(19) United States
(12) Patent Application Publication
(10) Pub. No.: US 2010/0068332 A1
(43) Pub. Date: Mar. 18, 2010

(54) ARRANGEMENT FOR THE SEALING OF CHANNEL SECTIONS IN A HOT OR COLD RUNNER

(76) Inventor: Herbert Gunther, Allendorf (DE)

Correspondence Address: CLARK & BRODY, 1090 VERMONT AVENUE, NW, SUITE 250, WASHINGTON, DC, 20005, US

(21) Appl. No.: 12/312,542

(22) PCT Filed: Sep. 26, 2007
(86) PCT No.: PCT/EP2007/008347

§ 371 Date: May 15, 2009

(30) Foreign Application Priority Data
Nov. 24, 2006 (DE) 20 2006 018 031.1

(51) Int. Cl. B29C 45/27

(52) U.S. Cl. 425/569

(57) ABSTRACT

The invention relates to an apparatus closing and/or connecting and/or deviating duct segments (12a) in a hot or cold runner manifold (10; 80) fitted with at least one flow duct (12) which is loaded with a plasticized material and which by means of stoppers (18; 82; 100; 110; 120) affixed to said manifold is sealable in fluid-tight manner and/or deviatable and/or connectable with a further flow duct. To create an improved apparatus to close duct segments (12a) in a hot/cold runner manifold (10; 80), each stopper (18: 82; 100; 110; 120) is affixed to the manifold in a recess running substantially perpendicularly to the duct segment (12a) and crossing latter. Furthermore each stopper (18; 82; 100; 110; 120) comprises at least one circumferential surface (24; 86) which when the apparatus is operating shall rest in fluid-tight manner against this opposite recess surface.

The present invention relates to an apparatus for sealing and/or connecting and/or deviating duct segments in a hot or cold runner manifold, this manifold comprising at least one flow duct which can be loaded with a plasticized mass and which may be closed by fluid-tight stoppers mounted on the manifold and or be deviated and/or be connected to a further flow duct.

As regards hot-runner injection molding apparatus, it is known to mount cylindrical stoppers in the corner zone of a manifold runner to seal its ends and/or to connect angled duct segments to constitute a deflection element. Illustratively as disclosed in the EP 0 226 798 A patent document, the stoppers are configured coaxially at the ends of a main duct in order to set up communication in each instance between a deviating element and a conical hole. This deviating element continues in the form of an angled borehole in the stopper, said borehole leading to a manifold discharge aperture. A constriction is constituted at the borehole miter and mainly constitutes a flow impedance. If plasticized material gets stuck at that impedance, cleaning will be difficult or impossible, as a result of which the entire stopper must be replaced. Such a stopper is affixed in the manifold by soldering/brazing, and on that account mechanical cleaning is laborious.

A comparable design is known from DE 32 11 342 A. Therein a cone is subtended in each widened orifice of a manifold cross duct and can be closed by a unilaterally beveled latch affixed by a through-bolt in the manifold in pressure tight manner. This design entails unavoidable dead corners where residual material may accumulate, with the danger of operational difficulties affecting product quality and in any event hampering cleaning.

Designs constituting improvements on the above have already been proposed in the documents EP 0 523 549 A; EP 0 630 733 A and EP 0 845 345 A, namely conical steel inserts fitted with deviating boreholes and being ether clamped on the manifold by round-head screws or being tightened by adjusting screws or being encompassed by threaded bolts fitted with an internal cone. Even though such connections are operationally sound even at high injection pressures, their manufacturing cost is relatively high and the integration of the press-fit cone may well be complex. The positional congruence between the borehole in the cone and the borehole in the manifold may be difficult to attain, where not impossible. Also the position of the conical borehole in the manifold borehole depends on the applied compression. This dependency gets more problematic the more slender the cone. Dead corners and flow shadows wherein material deposits again are inevitable.

The German patent document DE 298 16 253.9 U offers a substantially improved solution relative to the above designs, namely being devoid of dead corners, offering apparatus sealing duct segments in a hot runner manifold which is fitted with at least one duct that can be fed with plasticized material, said duct being sealable in pressure-tight manner by stoppers detachably affixed to the manifold, the/each stopper being affixable to the manifold at an acute angle to the duct axis and having an end face which can be pressed in pressure-tight manner on an opposite closed annular surface enclosing or limiting a duct opening. Even at very high pressures, highly effective sealing is attained. The stopper constitute detachable sealing means allowing mechanical cleaning. Thanks to their oblique position, they may be rapidly assembled/disassembled, whereby the work entailed by a change in color or material can be completed in exceptionally little time. However the said oblique stopper configuration incurs the drawback that it demands much space, a feature that is undesirable in many applications. Again, on account of the oblique stopper mounting, it is difficult at best to use such apparatus in an application for sealing ducts passing a valve needle.

Based on the above discussed state of the art, one objective of the present invention is to offer an alternative and improved configuration to seal duct segments in a hot or cold runner manifold.

This problem is solved by the present invention by an apparatus defined in claim 1. The dependent claims relate to individual embodiment modes of the apparatus of the invention.

The present invention creates apparatus to seal and/or connect and/or deviate duct segments in a hot or cold runner manifold, this apparatus being fitted with at least one flow duct moving a plasticized material, this flow duct being made sealed fluid-tight by stoppers mounted on the manifold and/or being deviating and/or connectable to another flow duct. According to the present invention, the/each stopper is affixed to the hot or cold runner manifold in a recess substantially extending perpendicularly to the duct segment to be closed which it crosses, and comprises at least one peripheral surface which in the operational state rests in fluid-tight manner at a recess surface opposite said recess, the thermal coefficient of expansion of the stopper being selected larger than that of the recess in a manner that, at the operational temperature, the stopper's peripheral surface rests in sealing manner against the related recess surface.

Because of the substantially perpendicular position of the stopper relative to the flow duct segment to be closed together with generating sealing across a peripheral stopper surface, the apparatus of the present invention is compact compared to the case of DE 298 16 253 U, inventive sealing being assured between the stopper and the recess wall. Also dead corners may be eliminated. When said apparatus has been cooled to room temperature, the stopper is seated loosely and may be easily introduced/removed, as a result of which mechanical cleaning can be carried out in problem-free manner.

In a further variation of the present invention, the minimum of one stopper peripheral surface and the recess surface opposite it, in the assembled state of said apparatus, are at least partly solidly joined to each other to attain sealing between the stopper and the recess and/or a fixed stopper position within the recess. Illustratively solder or the like may be used for bonding.

The latter variation however incurs the drawback relative to the former that once the seal has been established, the stopper can only be removed from the recess at comparatively large effort, for instance to allow cleaning, and on that account the former variation is preferred.

Advantageously the stopper comprises at least one end face which can be forced onto an oppositely located annular surface of the recess, in this manner the stopper can be configured and affixed at a predetermined position. The end face can be forced in pressure-tight manner against the annular surface in order to establish further sealing between the recess and the stopper if so desired. For that purpose the stopper end face preferably is designed as a closed sealing ring at a compressive element guided along its axis, this sealing rim implementing contour-hugging sealing at the annular surface. In this manner inaccuracies or shifts of the annular surface and the end face are precluded. Advantageously the stopper end face is at least partly planar, namely at the sealing rim, in order to implement directly a tight geometric seal with the annular surface.

Advantageously the stopper is secured against radial rotation. Such irrotationality preferably is implemented by a dowel pin.

In one embodiment mode of the present invention, the stopper comprises a screw element accessible to a tool at or in its head. This screw element affixes the stopper against axial displacement. Said screw element may be separate from or integral with the stopper.

In one embodiment mode of the present invention, the stopper is fitted with at least one duct to connect to each other two flow duct segments configured at an angle to each other of the hot or cold runner manifold and/or to deflect a flow duct segment at an angle in a way that a plasticized material flowing through the hot or cold runner manifold is able to flow from one flow duct segment through the stopper illustratively into another flow duct segment.

In yet another embodiment mode of the present invention, its stopper comprises a passageway for a valve needle. Preferably a sealing bush for the valve needle is mounted on the stopper, as a result of which plasticized material passing through the stopper is precluded from leaking through the passageway passing the valve needle.

Further features, particulars and advantages are disclosed in the wording of the claims and in the description below relating to the appended drawing.

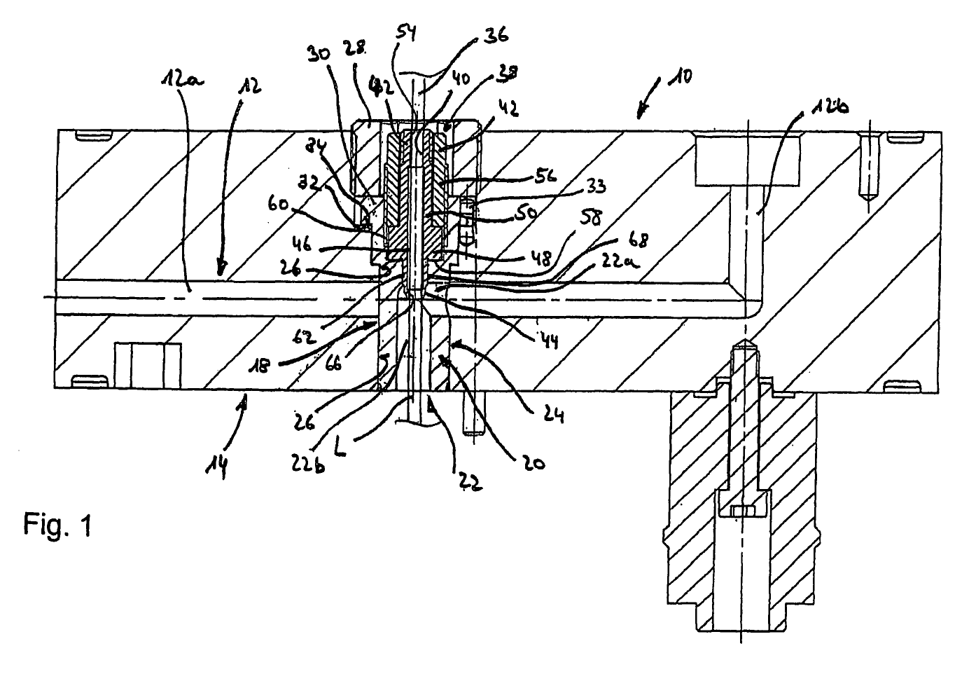

FIG. 1 is a cross-sectional view of a first embodiment mode of the apparatus of the present invention to close a duct segment and to deviate a further duct segment in a hot runner manifold,

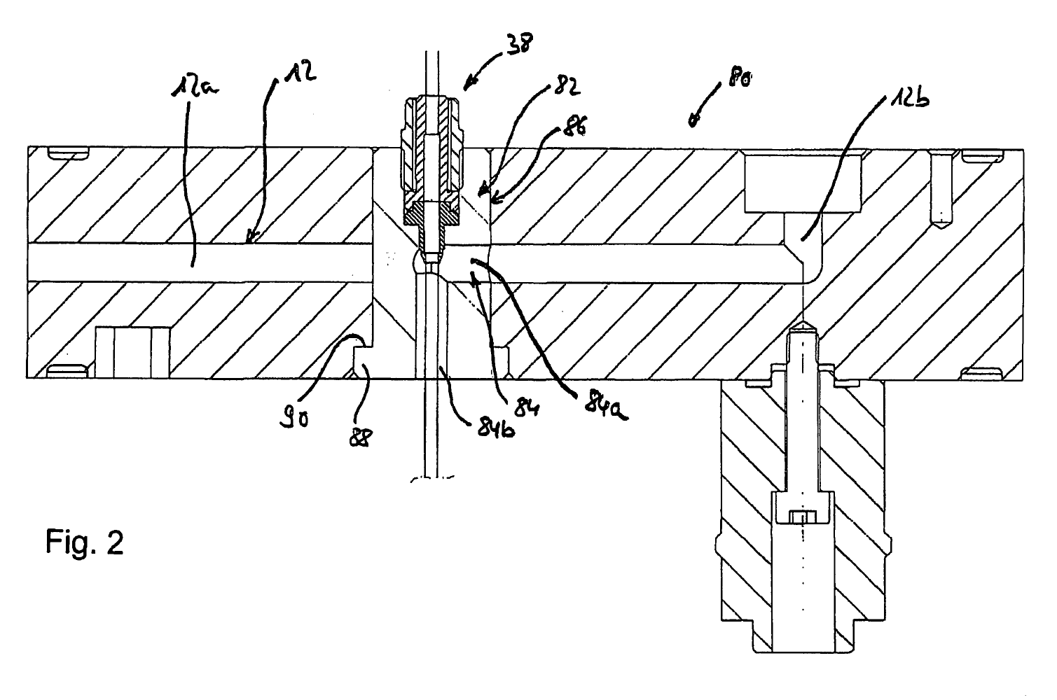

FIG. 2 is a cross-sectional elevation of a second embodiment mode of the present invention to close a duct segment and to deviate a further duct segment of a hot runner manifold,

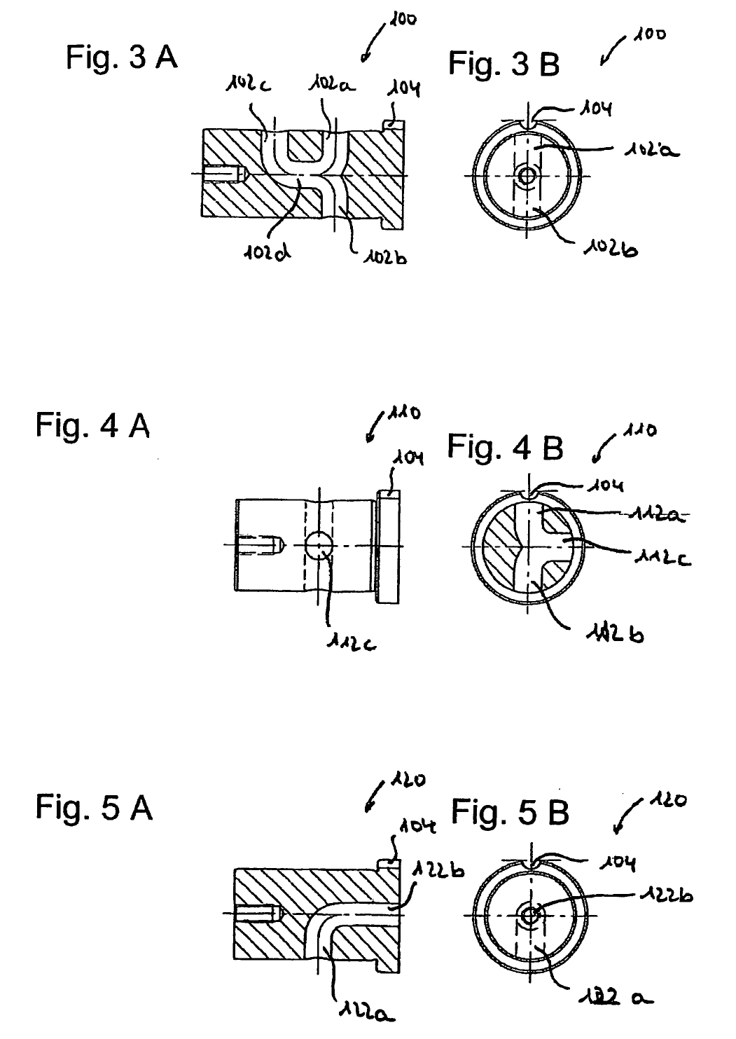

FIG. 3A is a cross-sectional view of a further alternative embodiment of a stopper connecting flow ducts in a hot runner manifold,

FIG. 3B is a sectional topview of the stopper of FIG. 3A,

FIG. 4A is a cross-sectional view of yet another alternative embodiment mode of a stopper connecting duct segments in a hot runner manifold,

FIG. 4B is a sectional topview of the stopper of FIG. 4A,

FIG. 5A is a sectional elevation of yet another alternative embodiment mode of a stopper connecting a duct segment to another and to close a further duct segment in a hot runner manifold, and

FIG. 5B is a sectional topview of the stopper of FIG. 5A.

Below, identical reference numerals denote similar/identical components.

The hot runner manifold denoted as a whole by 10 in FIG. 1 is part of injection molding equipment for manufacturing molded parts using a fluid material, illustratively a plastic melt. A flow duct 12 with a main flow duct 12a and an accessory flow duct 12b branched on the duct 12a is constituted in the hot runner manifold 12. The main flow duct 12a as well as the accessory flow duct 12b illustratively are fashioned as boreholes in the hot runner manifold 10. In order to deviate downward a melt entering the accessory flow duct 12b and flowing through the main duct 12a, a recess—crossing the accessory flow duct 12a and acting as a continuous borehole running substantially perpendicularly to the main flow duct 12a—receives a stopper 18. In the present instance the stopper 18 comprises a rotationally symmetrical bush 20 in which are constituted a duct 22 that runs radially inward from the circumferential surface of the bush 20 and comprises a main duct segment 22a continuing the main flow duct 12a, further an accessory duct segment 22b configured substantially perpendicularly to the main duct segment 22a and connected to it, the segment 22b running down from the segment 22a along the longitudinal axis L. The bush 20 is fitted with a circumferential surface 24 resting in fluid-tight manner against the opposite surfaces 26 of the hot runner manifold 10. Such fluid-tight contact is implemented by selecting the mutual fits in a manner that, in the cold state of the manifold plate 10, the stopper 18 can be inserted with little play into the recess. Moreover the thermal coefficient of expansion of the bush 20 is selected to be larger than that of the hot runner manifold 10 in a way that the circumferential surface 24 of the bush 20 with increasing temperature of said manifold shall rest in sealing manner against the matching surfaces of said manifold. Preferably the thermal expansion coefficient of the hot runner manifold plate 10 is approximately 12×10⁻⁶/° K and that of the stopper 18 about 19×10⁻⁶/° K. A seal is produced in this manner that shall preclude—when the stopper 18 is operative—the melt from flowing up or down in the segment of the main flow duct 12a blocked by the stopper 18 or outside along the bush 20. Alternatively a conventional fluid-tight, force-fit may be produced between the circumferential surface 24 of the bush 20 and the opposite surfaces 26 of the hot runner manifold 10 by cooling this bush 20 when it is being assembled and heating the hot runner manifold in the region of the surfaces 26.

Furthermore the stopper 18 comprises a screw element 28 fitted with an external thread engaging a matching inside thread of the hot runner manifold 10. The screw element 28 presses from above on an offset 30 configured at the end side of the bush 20, as a result of which an end face 32 of the bush 20 situated underneath the offset 30 and pointing down is forced against an annular surface 34 opposite same and configured in the hot runner manifold. In this manner the axial position of the bush 20 is fixed in the recess of the hot runner manifold 10. The end face 32 of the bush 20 and the annular surface 34 of the hot runner manifold also may be designed in a manner and may cooperate in a way to produce a further seal between the bush 20 and the hot runner manifold 10—if so desired. The bush 20 is radially positioned in the recess by a rotation-blocking element which in this case takes the form of a dowel 33, for the purpose of aligning the main duct segment 22a and the main to flow duct 12a.

The accessory duct segment 22b of the duct 22 subtended in the bush 20 issues into an omitted needle valve nozzle mounted at the underside 14 of the hot runner manifold 10.

Each needle valve nozzle is fitted with a preferably externally heated nozzle (also omitted) which is fitted with a material feed pipe concentric with the longitudinal axis L and continuing the accessory duct segment 22b. Latter terminates into a first nozzle output element constituting at its end a nozzle discharge aperture by means of which the material to be processed is fed through a sprue aperture to a separable mold insert (also omitted).

A valve needle 36 is used to open and close the gate preferably constituted in the mold insert, said needle 36 longitudinally passing through both the flow duct in the needle valve nozzle and the accessory duct segment 22b of the bush 20 of the stopper 18 being operationally displaced by an omitted mechanical, electric, pneumatic or hydraulic drive into a closing or open position. In the closed position the valve needle 36 passes, by means of a terminal sealing element, through the nozzle discharge aperture into the gate which it seals.

A guide shell 38 fitted with a central continuous borehole 40 is configured in the bush 20 of the stopper 18 to guide and seal the valve needle 36, the inside diameter of said borehole 40 in the end zones 42, 44 of the guide shell 38 matching the outside diameter of the valve needle 36 except for a slight play of displacement. As a result said needle is centrally guide and supported within the guide shell 38.

A cylinder-like free space 46 is subtended between the end respectively guide zones 42 and 44 and comprises an inside diameter slightly larger than the outside diameter of the valve needle 36. During injection molding, said free space 46 by design receives a slight quantity of flowable material from the main flow duct 12a, this feature assuring sealing the valve needle 36 relative to the main flow duct 12a and the mold environment. Simultaneously the fluid material within said free space 46 acts as a lubricant, thereby reducing the friction between the valve needle 36 and the guide shell 38.

The guide shell 38 is fitted with a widened flange 48 centrally seated in a recess 50 of the bush 20 of the stopper 18. Above the flange 48, the guide shell 38 comprises a main part 50 of lesser outside diameter which constitutes the terminal (upper) guide zone 42. Said zone 42 by its inside cylindrical circumference encloses the valve needle 36 except for a slight displacement play. At the same time the guide zone 42 upwardly limits the cylindrical free space 46, assuring that the processing material therein may not leak to the outside.

The main part 50 is coaxially enclosed by a threaded muff 56. Said muff's outside thread engages a matching inside thread of the bush 20. Once the said muff 56 is threaded into the bush 20 of the stopper 18, the guide shell 38 shall be affixed in this bush 20. In the process, the bottom 58 of the recess 60 and the (unreferenced) underside of the flange 48 are superposed in mechanically interlocking manner, as a result of which the guide shell 38 is fixed in place not only in the bush 20, but simultaneously it is also sealed by means of a surface perpendicularly to the longitudinal axis L.

Underneath the flange 48, the guide shell 38 is fitted (in the direction of the needle valve nozzle) with a neck portion 62 of which the outside diameter also is less than that of the flange 48. The lower end of the neck portion 62 constitutes the (lower) guide zone 44 which by its cylindrical inside circumference 66 encloses the valve needle 36 except for a slight play of displacement and commensurately limits downward the cylindric free space 46.

A continuous borehole 68 is fitted between the recess 60 and the accessory duct segment 22b to receive the neck portion 62 in the bush 20 of the stopper 18, the inside diameter of said borehole 68 substantially matching the outside diameter of the neck portion 62. Said neck portion 62 extends as far as the accessory duct segment 22b, said end zone 44—by its inside circumference enclosing the valve needle 36 and its (unreferenced) conical surface constituted at the level of the inside circumference 66 the accessory duct segment 22b—entering the accessory duct segment 22b radially to and concentrically with the longitudinal axis L. The guide zone 44 for the valve needle 36 therefore is situated completely within the flow of the processing material, said conical surface subtending a contacting surface for said material, where said contact surface as well as the valve needle 36 is immersed on all sides by said material in the main duct segment 22b.

Operating the needle seal respectively the guide shell 38 depends substantially on the elastically deforming wall of the end zone 44 situated in the main duct segment 22b. When the valve needle 36 opens, it first slides unhampered within the guide shell 38 from the closed into the open position, the end zones 42 and 44 sliding along the outer circumference of the valve needle 36 with little displacement play. Once said needle has is reached the end respectively the open position, the injection pressure is raised, that is the melt to be processed is forced at high pressure through the flow duct 12 into the mold nest. In this process the fluid material flows uniformly all around the valve needle 36 and the conical surface of the end zone 44, the latter being radially compressed on account of its thin wall. The cylindrical inside circumference 66 rests like a closing or a valve element in mechanically interlocking and sealing manner against the outer circumference of the valve needle 36, as a result of which, during injection molding, processing material coming from the accessory duct segment 22b no longer may enter the free space of the guide shell 38. Accordingly, processing material no longer may pass through the guide shell 38 out of the mold into the ambience at the time the accessory duct segment 22b is highly pressurized. Moreover the valve needle 36 is affixed in position concentrically about the longitudinal axis L. Said needle no longer can be deviating by the flowing processing material out of its central position, this feature being advantageous to the flow conditions in the accessory duct segment 22b.

Once the injection cycle has been completed, the pressure in the ducts 12a, 12b, 22a and 22b decays. On account of its elasticity, the end zone 44 resumes its initial shape and the inside circumference 66 of the end zone 44 detaches off the outer circumference of the valve needle 36. This needle can be moved unhampered into the closed position.

It is understood that the wall thickness of the steel-based end zone 44 is selected in a manner that the end zone may deform within the elastic range of said steel and that the slight displacement play between the valve needle 36 and the inner circumference 66 is overcome by the processing material's pressure so that, during the mold's high-pressure phase, the valve needle 36 is stopped centrally and processing material is prevented from leaking outside. Nevertheless the valve needle 36 is accurately guided between the individual pressure cycles within the mutually spaced end zones 42 and 44.

FIG. 2 shows a further embodiment mode of apparatus of the present invention used to close duct segments in a hot runner manifold 80. This hot runner manifold 80 comprises a flow duct 12 fitted with a main flow duct 12a and an accessory flow duct 12 branched off the duct 12a. In order to deviate downward the melt entering the flow duct 12b and flowing through the main flow duct 12a, a stopper 82 is inserted into a recess which crosses the flow duct 12a and which is designed as a continuous borehole and substantially runs perpendicularly to the direction of the main flow duct 12a, said stopper intersecting the main flow duct 12a. The stopper 82 is essentially a cylindrical component and comprises a duct 84 fitted with a main duct segment 84a running from the circumferential surface 86 of said stopper radially to its center to continue the main flow duct 12a and with an accessory duct segment 84b configured perpendicularly to the main duct segment 84a and connected to it, said accessory duct segment 84b running from the main duct segment 84a down and along the longitudinal axis L. The stopper 82 is inserted in such manner into the recess of the hot runner manifold 80 that its circumferential surface 86 rests sealingly against the matching circumferential recess surface when the hot runner manifold is operational. For that purpose the fit between the circumferential surface of the stopper 82 and the recess circumferential surface is selected in a manner that—in the cooled state of the manifold plate 80—the stopper 82 may be inserted with a slight play into said recess. The thermal coefficient of expansion of the stopper 82 is substantially larger than that of the manifold plate 80, as a result of which the circumferential stopper surface 86, when exposed to the rising temperature during the operation of the manifold plate 80, rests in sealing manner against the circumferential recess surface while generating a force-fit, as a result of which no processing material can pass between the circumferential surface 86 of the stopper 82 and the manifold plate 80. Preferably the thermal coefficient of expansion of the manifold plate 80 is approximately 12×10⁻⁶/° K and that of the stopper is about 19×10⁻⁶/° K. In order to axially position the stopper 82 when inserted in the cold state of the manifold plate 80, a radially outward running offset 88 is provided at one free end of said stopper, the end face 89 of said offset resting against a matching annular surface 90 constituted in the said recess. In this manner the main flow duct 12a of the manifold plate 80 and the main duct segment 84a of the stopper 82 are reliably configured at the same height. The radial positioning of the stopper 82 in the recess and hence the alignment of the main flow duct 12a with the main duct segment 84a are carried out in the manner described in relation to the first embodiment mode using a rotation-blocking element such as a set screw (not shown in FIG. 2).

A guide shell 38 receiving the valve needle 36 is screwed into the stopper 82 by means of appropriate threads. The affixation means of the guide shell 38 with the stopper 82 substantially is the same as discussed in the embodiment shown in FIG. 1 and therefore is not discussed further here.

FIG. 3A is a cross-sectional elevation of a further embodiment of a stopper 100 of the present invention and FIG. 3B is a sectional topview of the stopper 100 of FIG. 3A. The stopper 100 serves to align and connect an omitted flow duct respectively two omitted and mutually aligned flow ducts of a hot runner manifold with a further (omitted) respectively two flow duct)s) running parallel to the above one(s) of the hot runner manifold in fluid tight manner. For that purpose the stopper 100 is fitted with corresponding duct segments 102a, 102b and 102c which continue the particular flow ducts to be connected to each other. This embodiment also comprises a duct segment 102d connecting to each other the three duct segments 102a, 102b and 102c. The stopper 100 is inserted into the hot runner manifold in the manner described in relation to the embodiments shown in FIGS. 1 and 2 and therefore such insertion is not discussed further here. The groove 104 of semicircular cross-section receives an omitted dowel or the like with which to keep irrotational the stopper 100 inserted into the hot runner manifold.

FIG. 4A is a cross-sectional elevation of a further embodiment of a stopper 110 of the present invention and FIG. 4B shows a sectional topview of the stopper 110 of FIG. 4A. The stopper 110 serves to connect in fluid-tight manner one omitted flow duct respectively two omitted and mutually aligned flow ducts of a hot runner manifold with another hot runner manifold flow duct (omitted and configured at the same height but perpendicular to said former, above flow duct(s). For that purpose corresponding and T-shaped duct segments 112a, 112b and 112C are subtended in the stopper 110 and continue the particular flow ducts to be connected to each other. The stopper 110 is inserted into the hot runner manifold similarly to the way described in relation to FIGS. 1 and 2 and therefore this procedure is not discussed here again. The cross-sectionally semi-circular groove 104 accommodates an omitted dowel blocking any rotation of the stopper 110 in the hot runner manifold.

FIG. 5A is a cross-sectional elevation of a further embodiment of a stopper 120 of the present invention and FIG. 5B is a sectional topview of the stopper 120 of FIG. 5A. The stopper 120 serves to close an omitted flow duct and to deviate upward a further, also omitted flow duct. For that purpose duct segments 122a and 122b are fitted on the stopper 120, the segment 122a continuing the flow duct to be deviated and the segment 122b deviating upward said segment 122a. The flow duct respectively flow duct segment is sealed fluid-tight by means of the circumferential surface of the stopper 120. The insertion of the stopper 120 into the hot runner manifold is implemented similarly to the procedure used for the embodiment modes described in relation to FIGS. 1 and 2 and will not be discussed further here. The cross-sectionally semi-circular groove 104 serves to insert an omitted dowel acting as a rotation blocking element of the stopper 120 inserted into the hot runner manifold.

Be it borne in mind that basically the components 28 and 56 also may be designed with locknuts and the like, though this features is not shown in the appended Figures. Such an embodiment variation precludes unintentionally loosening the components for instance due to thermally or mechanically caused displacements.

The invention is not restricted to the above discussed embodiment modes of the inventive apparatus. While the above discussed embodiment modes relate to a hot runner manifold, the present invention also may apply to a cold runner manifold, this application being claimed within the scope of the present invention. Also modifications and changes are feasible without thereby transcending the scope of protection of the present invention defined by the appended claims.

All features and advantages explicit from and implicit in the claims, specification and drawing, including design details, spatial configurations and procedural steps may be inventive per se as well as in arbitrary combinations. In particular individual features of the above described embodiment modes may be exchanged where meaningful.

### LIST OF REFERENCE SYMBOLS

10 hot runner manifold
12 flow duct
12a main flow duct
12b accessory flow duct
14 underside
18 stopper
20 bush
22 duct
22a main duct segment
22 accessory duct segment
24 circumferential surface
26 surfaces
28 screw element
30 offset
32 end face
33 dowel
34 annular surface
36 valve needle
38 guide shell
40 continuous borehole
42 end zone
44 end zone
46 free space
48 flange
50 main part
54 inside circumference
56 threaded muff
58 bottom
60 recess
62 neck portion
66 inner circumference
68 continuous borehole
80 hot runner manifold
82 stopper
84 duct
84a main duct segment
84b accessory duct segment
86 circumferential surface
88 offset
89 end face
90 annular surface
100 stopper
102a duct segment
102b duct segment
102c duct segment
102d duct segment
104 groove
110 stopper
112a duct segment
112b duct segment
102c duct segment
120 stopper
122a duct segment
122b duct segment
L longitudinal axis

1. An apparatus to close and/or connect and/or deviate duct segments (12a) in a hot or cold runner manifold (10, 80) that is fitted with at least one flow duct (12) which may be loaded with a plasticized material and which may be closed by stoppers (18, 82; 100; 110; 120) affixed to the hot or cold runner manifold (10; 80) in fluid-tight manner and/or be deviated and/or connected to a further flow duct, each stopper (18; 82; 100; 110; 120) being affixable to the hot or cold runner manifold (10; 80) within a recess running substantially perpendicularly to the duct segment (12a) to be closed and comprising at least one circumferential surface (24; 86) which in operation rests in fluid-tight manner at a recess surface opposite said circumferential surface, the thermal coefficient of expansion of the stopper (18; 82; 100; 110; 120) being larger than that of the recess' material to such an extent that, at operational temperature, the circumferential surface (24; 86) of the stopper (18; 82; 100; 110; 120) shall rest against the recess surface.

2. Apparatus as claimed in claim 1, the minimum of circumferential surface (24; 86) of the stopper (18; 82; 100; 110; 120) and the recess surface opposite it are at least in part integrally joined in the assembled apparatus.

3. Apparatus as claimed in claim 1, where the stopper (18; 82; 100; 110; 120) comprises at least one end face (32; 89) which can be forced onto an opposite annular surface (30; 90) constituted in the recess for the purpose of axially positioning the stopper (18; 100; 110; 120) in said recess.

4. Apparatus as claimed in claim 3, wherein the end face (32; 89) of the stopper (18; 82; 100, 110; 120) can be forced in pressure-proof manner on the annular surface (34; 90).

5. Apparatus as claimed in claim 4, where the end face (32; 89) of the stopper (18; 100; 110; 120) is in the form of a sealing rim.

6. Apparatus as claimed in claim 4, where the minimum of one end face (32; 89) of the stopper (18; 82; 100; 110; 120) is at least partly planar, namely at the sealing rim.

7. Apparatus as claimed in claim 1, where the stopper (18; 82; 100; 110; 120) is radially fixed in place by a rotation-blocking element.

8. Apparatus as claimed in claim 7, where the rotation-blocking element is a dowel (33).

9. Apparatus as claimed in claim 1 wherein the stopper (18) comprises a screw element (28) the head of which is accessible to a tool.

10. Apparatus as claimed in claim 1, where the stopper (18; 82) is fitted with a duct (22) to deviate and/or connect duct segments of a hot or cold runner manifold (10; 80).

11. Apparatus as claimed in claim 1, wherein the stopper (81; 82) is fitted with a transit aperture (40) passing a valve needle (36).

12. Apparatus as claimed in claim 11, wherein a guide shell (38) for the valve needle (36) is fitted in the stopper (18; 82).
